(19) United States
(12) Patent Application Publication
(10) Pub. No.: US 2006/0125369 A1
(43) Pub. Date: Jun. 15, 2006

(54) Field emission lighting device and method for making the same

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/301,787

(22) Filed: Dec. 13, 2005

(30) Foreign Application Priority Data
Dec. 15, 2004 (CN) 200410077566.0

(51) Int. Cl. H01J 1/02; H01J 9/02

(52) U.S. Cl. 313/309

(57) ABSTRACT

A field emission lighting device and a method making the field emission lighting device are disclosed. The field emission lighting device includes a cathode, an anode, at least one emitter base, at least one conductive emitter tip, and a fluorescence layer. The emitter base is formed on the cathode and is made of diamond-like carbon. Each emitter tip is formed on a respective emitter base. The fluorescence layer is formed on the anode. In addition, each emitter tip has a bottom portion and a top portion. The bottom portion of the emitter tip has a cross-section size (i.e., diameter/width) essentially equal to the cross-section size of the emitter base. The emitter tip and the emitter base have a nanometer-magnitude size. The emitter base and a corresponding single emitter tip together form an emitter unit of the field emission lighting device.

### CROSS-REFERENCE TO RELATED APPLICATION

This application is related to a copending U.S. patent application filed on Jul. 29, 2005 and entitled “FIELD EMISSION LIGHTING DEVICE” with the same assignee. The disclosure of the above-identified application is incorporated herein by reference.

### BACKGROUND

1. Field of the Invention

The present invention relates to electronic lighting technology and, particularly, to a field emission lighting device and a method for making the field emission lighting device.

2. Discussion of the Related Art

Conventional light sources generally include combustion-based light sources, incandescent light sources, and fluorescent light sources. The fluorescent light sources include, for example, high-intensity discharge (HID) lamps and light emitting diode (LED) lamps.

As regards a typical HID lamp, a low voltage has to be converted into a high voltage of about 2300V so as to excite an inert gas to thereby produce electric arc light. In operation, a constant working voltage of about 8000 V has to be maintained so as to keep the HID lamp lighting. Therefore, such HID lamp has to be equipped with a voltage converter. The need for such a converter increases power consumption and the complexity of the configuration of the HID lamp. Nowadays, the LED lamps have been widely used in small sized lamps. The LED lamps generally have low luminosity, however.

Field emission devices operate based on emission of electrons in a vacuum. In operation, electrons are extracted from micron-sized (or less) emitter tips under a strong electric field. The electrons are accelerated under the electric field and then bombard a fluorescent material. The fluorescent material then emits visible light. Field emission devices are generally compact in size, light in weight, and capable of providing a high brightness.

Emitter bases of a typical field emission device are generally comprised of metal or semiconductor materials, such as silicon. Nevertheless, such metal or semiconductor materials typically have a lower mechanical strength, relative to known metallic structural materials, such as aluminum alloys, titanium alloys, steel and iron.

What is needed, therefore, is a field emission lighting device that has an excellent mechanical strength and a high luminous efficiency.

What is also needed, therefore, is a method for making the above-described field emission lighting device.

### SUMMARY OF THE INVENTION

In a preferred embodiment, a field emission lighting device includes a cathode, an anode, at least one diamond-like carbon emitter base, at least one conductive emitter tip, and a fluorescence layer. The emitter base is formed on the cathode. The emitter tip is formed on the emitter base. The fluorescence layer is formed on the anode.

Preferably, the cathode includes a cathode main body and a functional layer disposed on the cathode main body The cathode main body is made, e.g., of a material selected from the group consisting of copper, silver, and gold (i.e., a noble metal).

In addition, the field emission lighting device includes a nucleation layer, a transparent upper substrate, a lower substrate, and a number of sidewalls. The nucleation layer is disposed on the cathode. The cathode is disposed on the lower substrate. The anode is disposed under the upper substrate. The sidewalls are interposed between the upper substrate and the lower substrate. Therefore, a chamber is defined by the sidewalls, the lower substrate and the upper substrate. The chamber generally is vacuumized for optimal operation of the field emission process.

Furthermore, the emitter base has a cross-section size in the range from about 10 nanometers to about 100 nanometers. Preferably, the emitter base has a base cross-section size (i.e., diameter/width) in the range from about 10 nanometers to about 50 nanometers. Each emitter tip has a bottom portion and a top portion. The bottom portion of the emitter tip has an emitter cross-section size (i.e., diameter/width) approximately equal to the base cross-section size. The top portion of the emitter tip has cross-section size in the range from about 0.5 nanometers to about 10 nanometers. The emitter base and a corresponding single emitter tip together have a total height in the range from about 100 nanometers to about 2000 nanometers.

A method for making a field emission lighting device, in accordance with another preferred embodiment, includes the steps of: providing a first substrate and forming a cathode thereon; forming a layer comprised of a diamond-like carbon on the cathode; forming a conductive layer on the diamond-like carbon layer; etching the conductive layer and the diamond-like carbon layer, thereby forming at least one diamond-like carbon emitter base and at least one conductive emitter tip on the respective emitter base; providing a second substrate and forming an anode thereon; depositing a fluorescence layer on the anode; assembling the anode to the cathode and forming a chamber therebetween and thereby attaining a field emission lighting device.

Preferably, the method includes a step of forming a nucleation layer on the cathode after providing the cathode. The diamond-like carbon layer is formed by a deposition method selected from the group consisting of a chemical vapor deposition method, a plasma-enhanced chemical vapor deposition method, and an ion-beam sputtering deposition method. The conductive layer is formed by a method selected from the group consisting of a vacuum sputtering, a magnetron sputtering method, and an ion-beam sputtering deposition method.

In addition, because the combined emitter tip and the emitter base have good mechanical strength, good electrical conductance, and excellent field-emission capability, the combined emitter tip and the emitter base may operate under relatively high-voltage electrical fields without the risk of being damaged.

A high-voltage electric field may be applied so as to obtain a high current of field emission. The high current of field emission enables the field emission lighting device to provide a high luminous efficiency and a satisfactory brightness. The brightness provided by the present field emission lighting device may reach about 10 to about 1000 times that of a comparable light emitting diode (LED) or high intensity discharge (HID) lamp.

Other advantages and novel features of the embodiments will become more apparent from the following detailed description when taken in conjunction with the accompanying drawings.

### BRIEF DESCRIPTION OF THE DRAWINGS

Many aspects of the field emission lighting device having the combined emitter tip and the emitter base can be better understood with reference to the following drawings. The components in the drawings are not necessarily to scale, the emphasis instead being placed upon clearly illustrating the principles of the present field emission lighting device. Moreover, in the drawings, like reference numerals designate corresponding parts throughout the several views.

FIG. 1 is a schematic, cross-sectional view of a field emission lighting device in accordance with a preferred embodiment; and

FIG. 2 is an enlarged view of an exemplary emitter unit of the field emission lighting device of FIG. 1.

### DETAILED DESCRIPTION OF PREFERRED EMBODIMENTS

Embodiments of the present field emission lighting device will now be described in detail below and with reference to the drawings.

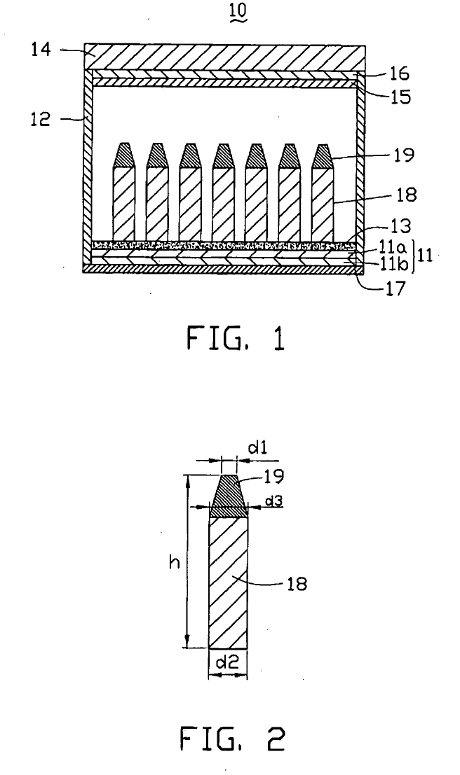

FIG. 1 illustrates a field emission lighting device 10 in accordance with a preferred embodiment. The field emission lighting device 10 mainly includes a cathode 11, a nucleation layer 13, a transparent upper substrate 14, a fluorescence layer 15, an anode 16, a low substrate 17, at least one electrically conductive emitter base 18, and at least one emitter tip 19. The cathode 11 is formed on the low substrate 17. The anode 16 is formed on an interior surface of the upper substrate 14. The fluorescence layer 15 is formed on the anode 16. The emitter base 18 is essentially made of diamond-like carbon (DLC). Each emitter tip 19 is formed on a respective emitter base 18.

The cathode 11 includes a cathode main body 11b and a functional layer 11a disposed on the cathode main body 11b. The cathode main body 11b is generally made, e.g., of a material selected from the group consisting of copper (Cu), silver (Ag), and gold (Au) (i.e., a noble metal, featuring high conductivity and superior oxidation resistance). The low substrate 17 may be made of a metal such as Cu or Ag, or a metal alloy such as a Cu—Ag alloy. Alternatively, the low substrate 17 may be made of nonmetal material, for example, silicon or silicon dioxide. The low substrate 17 advantageously has a surface configured to be smooth and not prone to crack, for facilitating formation of the cathode 11 thereon. The functional layer 11a preferably has a thickness of less than about 1 micrometer. The low substrate 17 advantageously has a thickness in the range from about 1 millimeter to about 10 millimeters.

In general, the cathode main body 11b, which is most advantageously made of silver or gold, has a relatively low mechanical strength. The functional layer 11a is advantageously comprised of a material having a relatively high mechanical strength, such as copper, nickel, and an alloy thereof. The functional layer 11a can effectively improve the mechanical strength of the cathode 11. The functional layer 11a is generally disposed on at least one of opposite surfaces of the cathode main body 11b.

The nucleation layer 13 preferably has a thickness of less than about 1 micrometer. The nucleation layer 13 is configured for facilitating deposition of an emitter base layer thereon. The emitter base layer and a conductive layer, which is subsequently deposited on the emitter base layer, are provided for forming the emitter base 18 and the emitter tip 19, respectively. The nucleation layer 13 is advantageously comprised of a material selected from the group consisting of iron (Fe), cobalt (Co), nickel (Ni), and other transition metals.

Referring also to FIG. 2, each emitter base 18 and the respective emitter tip 19 cooperatively form an emitter assembly or an emitter unit for the field emission lighting device 10. In the illustrated exemplary embodiment, the emitter base 18 is essentially made of DLC. The emitter base 18 formed of DLC has many valuable characteristics, such as excellent mechanical strength, good electrical conductivity, high hardness, high chemical stability, and high thermal conductivity. For example, the emitter base 18 can effectively dissipate heat generated from the cathode 11.

The emitter tip 19 is generally made of an emissive material and is advantageously selected from the group consisting of graphite-like carbon (GLC), niobium (Nb), and molybdenum (Mo). The emitter tip 19 is preferably formed of GLC. (It is noted that DLC and GLC are commonly used terms in the art with respect to such forms of carbon and thus are definitive within such context.)

The emitter base 18 is generally in a form of a cylinder. The emitter base 18 has a diameter d2 in the range from about 10 nanometers to about 100 nanometers. Preferably, the emitter base 18 has a diameter d2 in the range from about 10 nanometers to about 50 nanometers. The emitter tip 19 is in a form of a frustum of a cone. The emitter tip 19 includes a bottom portion and a top portion. The bottom portion has a diameter d3 approximately equal to a diameter d2 of the emitter base 18. The top portion of the emitter tip 19 has a diameter d1 in the range from about 0.5 nanometers to about 10 nanometers. The emitter tip 19 has an aspect ratio in the range from about 10 to about 4000. The aspect ratio is preferably in the range from about 20 to about 400. The emitter unit, including the emitter base 18 and the corresponding emitter tip 19, has a total height h in the range from about 100 nanometers to about 2000 nanometers.

Referring back to FIG. 1, the upper substrate 14 is formed of a transparent material, such as glass or silicon dioxide. The upper substrate 14 is generally in a form of a planar substrate.

Alternatively, the upper substrate 14 can be configured as a tubular substrate. The cathode 11 may be a metal filament disposed between the sidewalls 12. The cathode 11 could then be interposed between the sidewalls 12, thereby obviating the need for using a lower substrate 17 for supporting the cathode 11 thereon. The cathode 11 would preferably extend along a central axis of the tubular substrate. The emitter base 18 and the emitter tip 19 would be formed on an outside surface of the cathode 11. In fact, a field emission lighting device in this form would be a tubular light source.

The anode 16 is formed on the upper substrate 14 by a DC reactive sputtering technique or an RF reactive sputtering technique. The anode 16 is generally made of an indium tin oxide (ITO) material, for its favorable conductivity and transparency. The fluorescence layer 15 is formed on the anode 16. The fluorescence layer 15 is generally made of a phosphor material.

A number of sidewalls 12 are interposed between the lower substrate 17 and the upper substrate 14. A chamber 30 is bounded by the sidewalls 12, the lower substrate 17, and the upper substrate 14. The chamber 30 is generally vacuumized, thereby minimizing the resistance met by the electrons emitted from the emitter tip 19 prior to reaching the fluorescence layer 15.

In operation, a bias voltage is applied between the cathode 11 and the anode 16, thereby establishing an electric field. Electrons are extracted and accelerated from the emitter tip 19 and then bombard the fluorescence layer 15. As a result, the fluorescence layer 15 generates visible light after being bombarded by the electrons.

A method for making a field emission lighting device, in another preferred embodiment, comprises the steps of (a) providing a first substrate and forming a cathode thereon; (b) forming a layer made of diamond-like carbon (hereinafter, DLC layer) on the cathode; (c) forming a conductive layer on the DLC layer; (d) etching the conductive layer and the DLC layer, thereby forming at least one DLC emitter base and a corresponding conductive emitter tip on the respective emitter base; (e) providing a second substrate and forming an anode thereon; (f) forming a fluorescence layer on the anode; and (g) assembling the anode to the cathode and forming a chamber therebetween, thereby obtaining a field emission lighting device.

The cathode includes a cathode main body and a functional layer disposed on the cathode main body. The functional layer may be deposited on at least one of opposite surfaces of the cathode main body, for improving a mechanical strength of the total cathode. Preferably, a nucleation layer is formed on the cathode by a sputtering method subsequent to the step (a). The nucleation layer has a thickness of less than about 1 micrometer. The nucleation layer facilitates deposition of a DLC layer. A conductive layer is then deposited on the DLC layer.

The DLC layer and the conductive layer is formed by a deposition method such as a chemical vapor deposition method, a plasma-enhanced chemical vapor deposition method, or an ion-beam sputtering deposition method. The conductive layer is formed, e.g., by a sputtering method, such as a vacuum sputtering method, a magnetron sputtering method, or an ion-beam sputtering deposition method.

Furthermore, the conductive layer and the DLC layer are partially/selectively etched at the same time. The conductive layer and the DLC layer is etched by a method selected from a group consisting of a chemical etching method, a plasma etching method, a photo etching method, and a dry etching method. After the etching step, each emitter base has a respective emitter tip remaining thereon, thereby resulting in an emitter unit.

In the step (e), the second substrate is formed of a transparent material such as glass and silicon oxide. The anode may be made of an indium tin oxide (ITO) material or another transparent conductor by, e.g., a DC reactive sputtering technique or an RF reactive sputtering technique. The fluorescence layer, which is made of a phosphor material, is formed, for example, by a deposition method.

Moreover, sidewalls are interposed between the first and second substrates for forming a chamber therebetween, subsequent to the step (g). The chamber is vacuumized so as to minimize resistance encountered by emitted electrons, prior to reaching the fluorescence layer.

In the above-described preferred embodiments, because the emitter unit has excellent mechanical strength, good electrical conductance, and excellent field-emission capability, the emitter unit may operate under relatively high voltage electrical fields without the risk of being damaged.

When a high voltage electric field is applied, a high current of field emission can be obtained. The high current of field emission enables the field emission lighting device to provide a high luminous efficiency and a satisfactory brightness. The brightness provided by the present field emission lighting device may reach about 10 to about 1000 times that of a comparable light emitting diode (LED) or high intensity discharge (HID) lamp.

The field emission lighting device of the above-described preferred embodiments may be implemented into various illumination products. For example, the field emission lighting device may be employed as a headlight for an automobile or incorporated into residential or industrial lighting units.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A field emission lighting device comprising:
a cathode;
at least one emitter base extending from the cathode, the emitter base being comprised of diamond-like carbon;
at least one conductive emitter tip, each emitter tip being formed on a respective emitter base;
an anode disposed opposite from the cathode; and
a fluorescence layer formed on the anode.

2. The field emission lighting device of claim 1, wherein the emitter tip is comprised of a material selected from the group consisting of graphite-like carbon, molybdenum, and niobium.

3. The field emission lighting device of claim 2, wherein the emitter tip is comprised of graphite-like carbon.

4. The field emission lighting device of claim 1, wherein the cathode comprises a cathode main body and a functional layer formed on the cathode main body.

5. The field emission lighting device of claim 1, further comprising a nucleation layer formed on the cathode.

6. The field emission lighting device of claim 1, wherein the emitter base has a cross-section size in the range from about 10 nanometers to about 100 nanometers.

7. The field emission lighting device of claim 6, wherein the emitter base has a cross-section size in the range from about 10 nanometers to about 50 nanometers.

8. The field emission lighting device of claim 1, wherein the emitter tip has a bottom portion and a top portion, the bottom portion has a cross-section size essentially equal to a cross-section size of the emitter base.

9. The field emission lighting device of claim 8, wherein the top portion has a cross-section size in the range from about 0.5 nanometers to about 10 nanometers.

10. The field emission lighting device of claim 1, wherein the emitter base and the corresponding emitter tip has a total height in the range from about 100 nanometers to about 2000 nanometers.

11. A method for making a field emission lighting device, comprising the steps of:
providing a first substrate and forming an cathode thereon;
forming a layer comprised of diamond-like carbon on the cathode;
forming a conductive layer on the diamond-like carbon layer;
etching the conductive layer and the diamond-like carbon layer, thereby forming at least one diamond-like carbon emitter base and a conductive emitter tip on each respective emitter base;
providing a second substrate and forming an anode thereon;
forming a fluorescence layer on the anode; and
assembling the anode to the cathode, thereby attaining the field emission lighting device.

12. The method for making a field emission lighting device of claim 11, further comprising a step of forming a nucleation layer on the cathode after providing the cathode.

13. The method for making a field emission lighting device of claim 11, wherein the diamond-like carbon layer is formed by a deposition method selected from the group consisting of a chemical vapor deposition method, a plasma-enhanced chemical vapor deposition method, and an ion-beam sputtering deposition method.

14. The method for making a field emission lighting device of claim 11, wherein the conductive layer is formed by a sputtering method selected from the group consisting of a vacuum sputtering method, a magnetron sputtering method, and an ion-beam sputtering deposition method.

15. The method for making a field emission lighting device of claim 11, wherein the emitter tip is comprised of a material selected from the group consisting of graphite-like carbon, molybdenum, and niobium.

16. A method for making a field emission lighting device, comprising the steps of:
providing a first substrate and forming an cathode thereon;
forming a layer comprised of diamond-like carbon on the cathode;
forming a conductive layer comprised of graphite-like carbon on the diamond-like carbon layer;
etching the conductive layer and the diamond-like carbon layer, thereby forming at least one diamond-like carbon emitter base and a conductive emitter tip on each respective diamond-like carbon emitter base;
providing a second substrate and forming an anode thereon;
forming a fluorescence layer on the anode; and
assembling the anode to the cathode, thereby attaining the field emission lighting device.
